(19) United States
(12) Patent Application Publication
(10) Pub. No.: US 2025/0320901 A1
(43) Pub. Date: Oct. 16, 2025

(54) METHOD FOR ACTUATING A BRAKE ARRANGEMENT

(71) Applicant: Continental Automotive Technologies GmbH, Hannover (DE)

(72) Inventors: Aleksandar Stanojkovski, Kleinostheim (DE); Roland Caspari, Frankfurt (DE); Andreas Top, Bocholt (DE)

(73) Assignee: Continental Automotive Technologies GmbH, Hannover (DE)

(21) Appl. No.: 19/091,501

(22) Filed: Mar. 26, 2025

(30) Foreign Application Priority Data
Mar. 26, 2024 (DE) 10 2024 108 608.4

(51) Int. Cl. F16D 65/22; F16D 121/20; F16D 121/24; F16D 127/06

(52) U.S. Cl. CPC F16D 65/22; F16D 2121/20; F16D 2121/24; F16D 2127/06

(57) ABSTRACT

A method for actuating a brake arrangement, wherein a pawl defined for locking and unlocking a parking brake functionality of a brake arrangement otherwise embodied as a service brake is used. A method for actuating a brake arrangement comprises rotating a shaft in a first direction with a drive to apply a brake, rotating the shaft in a second direction with the drive to release a brake; and moving a pawl between a first position and a second position along a rectilinear travel distance with one of an actuating device and the drive. In the first position, the pawl is spaced apart from a gearwheel connected to the shaft in a fixed rotation ratio and in the second position, is in engagement with the gearwheel or can be brought into engagement by rotation of the shaft in the second direction.

### TECHNICAL FIELD

The embodiments relate to a method for actuating a brake arrangement.

### BACKGROUND

Brake arrangements are frequently used to decelerate motor vehicles in a targeted manner. For example, a speed can be reduced, possibly even to a standstill. There is increasingly the requirement that brake arrangements of this type not only act as a service brake when the vehicle is moving, but also implement a parking brake effect. The vehicle is held for an indefinite period of time during the activation of the parking brake function. This requires permanent locking.

### SUMMARY

It is an object to provide a method for actuating a brake arrangement.

A brake arrangement comprises a shaft, wherein, when the shaft is rotated in a first direction, application occurs and, when the shaft is rotated in a second direction, release occurs. This relates for example to a braking action, which can be realized, for example, by one or more brake shoes on a disk brake or drum brake. The brake arrangement has a gearwheel, which is connected to the shaft in a fixed rotation ratio. This can mean that the gearwheel is connected to the shaft for rotation therewith, i.e. rotates together with the shaft. However, it may also mean that there is a transmission between the shaft and the gearwheel, and therefore an alternative rotation ratio can be achieved. In this case, however, there is typically a defined connection between a rotation of the shaft and a rotation of the gearwheel. This is typically effective in both directions. The brake arrangement has a drive for rotating the shaft. This may be, for example, an electric motor. The brake arrangement has a pawl, wherein the pawl is movable between a first position and a second position. The pawl may be movable along a rectilinear (straight) travel distance between the first position and the second position. In the first position, the pawl is spaced apart from the gearwheel and, in the second position, is in engagement with the gearwheel or at least can be brought into engagement by rotation of the shaft in the second direction. In other words, the first position corresponds to a state in which the gearwheel is rotatable completely independently of the pawl, and, in the second position, the pawl acts to block the gearwheel, at least after the gearwheel has rotated until it comes into engagement with the pawl. The brake arrangement has an actuating device for moving the pawl between the first position and the second position. This may be for example a solenoid. The latter can move the pawl directly linearly. In the case of a monostable pawl, there is typically a preloading device which preloads the pawl into a position, for example into the first position. The pawl can then be moved out of this position, e.g. by actuation of the actuating device. In the case of a bistable pawl, even without actuation of the actuating device, the pawl remains in each of the positions until the actuating device is actuated again for active movement.

The feature that the actuating device is designed to drive the pawl between the first position and the second position can therefore for example mean that
a) the actuating device is designed only for actively moving the pawl between the first position and the second position, and an automatic restoring device (for example, a spring) is provided for moving the pawl back out of the second position into the first position, or
b) the actuating device is designed both for actively moving the pawl between the first position and the second position and also for actively moving the pawl between the second position and the first position, or
c) the actuating device is designed only for actively moving the pawl between the second position and the first position and an automatic restoring device (for example a spring) is provided for moving the pawl back out of the first position into the second position.

The method may comprise actuating the actuating device and/or the drive to move the pawl into a position.

By means of such a design, the brake arrangement can be used not only as a service brake, but can also be used at the same time as a parking brake. In a functionality as a service brake, the pawl is typically located in its first position, and therefore the gearwheel and thus also the shaft can rotate freely. This is typically required for a functionality as a service brake. The brake is frequently applied and then released again. If, by contrast, the pawl is located in the second position, it blocks the gearwheel against further rotation, for example in the second direction. The brake arrangement is thus held in an applied state such that the braking action is in principle maintained for an indefinite period of time. A vehicle can thus be reliably kept at a standstill. The pawl thus secures for example the application position of the brake.

According to one embodiment, the actuating device and the drive can be controlled in such a way that, during movement of the pawl from the first position into the second position and/or during movement of the pawl from the second position into the first position, there is at least temporary contact between the pawl and the gearwheel away from the second position such that a free movement length of the pawl is reduced. Free travel/free movement should be understood as meaning a movement of the pawl during which said pawl does not touch the gearwheel. The temporary contact either stops the pawl along the travel distance temporarily and thereby reduces the respectively achieved maximum speed of the pawl during each coming into contact with the gearwheel or the overall travel distance is reduced so that the maximum speed of the pawl is also reduced, for example when striking against the actuating device in the first position. The maximum speed of the pawl when striking against the gearwheel or actuating device strongly correlates with the unwanted noise produced by the brake arrangement and with the rate of wear of the pawl and gearwheel, and therefore both aspects can be addressed by this solution. For example, magnetic actuation of the pawl may cause the pawl to accelerate continuously along the free travel distance. The term “away from the second position” should be understood in such a way that this contact position is spaced apart from the second position for example over at least 10%, e.g. at least 25%, of the entire travel distance between the first position and the second position.

Before the pawl is moved from the first position into the second position, the drive may be actuated in such a way that the pawl, on the path into the second position, firstly contacts the gearwheel, for example on a radial outer side of a tooth, and comes to a stop. This divides the travel distance into two parts and reduces the maximum speed of the pawl when striking against the gearwheel, since the pawl is not accelerated for as long. Accordingly, the unwanted production of noise and the wear decrease.

For example, after the pawl is stopped against the gearwheel, the drive can be actuated again such that the pawl continues to move into the second position. In principle, this can be done by rotating the gearwheel in the first direction or in the second direction, but this depends on the shape of the gearwheel and the shape of the pawl. On the second portion of the movement path, following the stop, to the second position, the pawl can then accelerate freely again, depending on the shape of the gearwheel (unless it slips in a controlled manner along the gearwheel into the second position) and can contact the gearwheel a second time. However, both new contacts of the pawl with the gearwheel are made at a lower maximum speed than if the pawl can freely accelerate along the entire travel distance from the first position to the second position.

For example, the contact on the radial outer side of the tooth can take place against a portion of the tooth that runs substantially perpendicular to the direction of movement of the pawl. The portion of the tooth that runs substantially perpendicular to the direction of movement of the pawl may be, for example, a radially outer tooth back. Contact at such a flat portion reduces the risk of breaking an edge of the gearwheel or pawl.

In one embodiment, for the pawl to move from the second position into the first position, the drive is initially actuated in such a way that the gearwheel presses the pawl radially outward such that the pawl covers part of the travel distance in contact with the gearwheel. The gearwheel can then guide the pawl back over part of the travel distance, so that the acceleration path and thus the maximum speed of the pawl when striking against a seat on the actuating device are reduced. The pushing radially outward can also be carried out against a force acting on the pawl, for example against a force of the actuating device or a force of a restoring device.

In a further embodiment, the drive rotates the gearwheel in the first direction such that the pawl is pushed radially outward, e.g. along a back of a tooth. The gearwheel then rotates, for example, by at least half a tooth distance (e.g. 0.5 to 0.9 tooth distances) in the circumferential direction in the first direction. For example, the pawl is pushed radially outward from a tooth pocket over the back of an adjacent tooth.

For example, the actuating device remains actuated, while the gearwheel presses the pawl radially outward and the actuation of the actuating device is then reduced or deactivated only after the pawl has traveled along part, for example at least 10%, e.g. at least 25%, of the travel distance from the second position to the first position, and therefore the pawl then travels along the rest of the travel distance to the first position without contact with the gearwheel. The pawl is then kept in contact with the gearwheel by the actuating device that is still actuated, while the pawl is pushed radially outward by the rotation of the gearwheel, and thus part of the travel distance is traveled along. Only when the pawl has reached a position that is radially further outward (opposite the second position) on the gearwheel is the actuating device deactivated, so that the pawl travels along the rest of the travel distance to the first position without contact with the gearwheel.

If the pawl is moved from the first position to the second position, the gearwheel is typically subsequently rotated for locking purposes.

According to a further embodiment, which can be combined with the previously described embodiment, but can also be realized independently, for the pawl to move, the actuating device is activated with a current and/or a voltage in accordance with superimposition of a ramp and a pulse or a plurality of pulses. The controller can refer to the current or the voltage, which are typically equivalent to each other. For example, a ramp means that current or voltage continuously increases or decreases, for example linearly, over time. A pulse typically means that for only a short period of time, a much higher or much lower current is present than the current provided by the ramp. Such a pulse can, for example, ensure that a static frictional force is overcome. The ramp can also ensure a desired movement.

For example starting from the ramp, the pulses can point in the same direction as a profile of the ramp with increasing time. Thus, a pulse anticipates a further profile of the ramp. For example, a pulse at the beginning can thus ensure a rapid release, wherein later over the course of time the current or voltage in any case reaches the value that is already provided at the pulse.

Alternatively or in addition, starting from the ramp, the pulses can point in the opposite direction to a profile of the ramp with increasing time.

According to one embodiment, only one pulse is used. In an alternative embodiment, a plurality of pulses are used, e.g., two pulses, three pulses, or more than three pulses.

For example, a pulse can be used at the start of the ramp. By this means, it is possible, for example, to ensure immediate actuation.

For example a safety value which is higher or lower than all of the values used with the ramp can be set after the ramp. This means that, in the event that a gentle movement during the application of the ramp and possibly the pulses was not possible, for example due to excessive static friction, the desired position of the pawl can be reached at the latest when the safety value is set. A switching current or a switching voltage can be a term for a safety value.

A holding value can be used after the ramp and/or after the safety value. This ensures that the pawl remains in the desired position. This is typically lower than a safety value since the pawl only needs to be held in this state rather than being moved further. For example, the holding value can be higher or lower than the safety value and/or than all of the values used with the ramp.

For example, at least one pulse can be used until a movement of the pawl is sensed. This allows active monitoring of the pawl to be used to sense when the latter is moving. A pulse is then applied until it is sufficient to set the pawl in motion. The pulse can then be withdrawn again, and, for example, the further course of the ramp can be followed. This can trigger an initial movement, and then the ramp can prevent a movement from occurring too quickly, as would perhaps happen if the pulse were to continue to be applied.

For example, a plurality of successive pulses can be used until a movement of the pawl is sensed. This corresponds to a similar principle to that described above, only with a plurality of pulses, which can lead in each case to a release of a possibly stuck pawl.

The ramp can be for example ascending, descending or constant. An ascending ramp is used for example when the pawl is to be pushed ever further away against the force of a spring. A descending ramp can be used, for example, if the effect of a spring at the beginning may be greatly compensated, with this compensation becoming smaller over time when the ramp is descending and, as a result, the pawl is moved. A constant ramp may correspond to a constant value, which can be used, for example, for a certain desired movement.

The height of a pulse or a plurality of pulses can be determined for example on the basis of a measurement, from which magnitude the pawl moves starting from a certain position. For example, it can be measured from which value the pawl moves, and a somewhat higher or lower value can be used.

According to another embodiment, which can be combined with the embodiments previously described herein, but can also be used by itself, for the pawl to move, the actuating device is activated in a first time window with a first pulse width modulation frequency and is activated in a second time window following the first time window with a second pulse width modulation frequency which is different, for example higher than the first pulse width modulation frequency. The effect which can be achieved for example by such a sequence of pulse width modulation frequencies is that, at the initially lower pulse width modulation frequency, the current has a higher peak-peak value, which facilitates release of a stuck pawl. A higher pulse width modulation frequency can then be used again to allow a more accurate setting of current or voltage.

A time window may be continuous, but it can also be divided into a plurality of sub-time windows. In this case, the matter of which time window is present first typically depends on which time window first has a sub-time window.

For example, the first pulse width modulation frequency can be at least 1 kHz and/or at most 6 kHz. For example, the second pulse width modulation frequency can be at least 6 kHz and/or at most 30 kHz. For example, the first frequency can be at maximum half of the second frequency. However, other values can in principle also be used.

The procedure with different pulse width modulation frequencies depending on the time window can be carried out for example as described further above with reference to the superimposition of ramp and pulse or pulses. For example, the first time window can cover the ramp or can be identical to the ramp. In regard to the embodiment described further above, reference can be made to all of the embodiments and variants described herein.

For example, the method as described above with reference to the use of different pulse width modulation frequencies in first and second time windows can be carried out as described further above with reference to the superimposition of ramp and pulse or pulses, for example with the second time window being able to begin after the ramp or directly after the ramp.

For example, the first time window may cover one or more pulses and/or can be identical to the pulses.

Such embodiments have been found to be useful for typical applications. The effects of the superimposition of ramp and pulse or pulses and the use of different pulse width modulation frequencies can be combined.

The time windows can for example have a length of in each case at least 1 ms or 2 ms and/or at most 4 ms or 5 ms or 6 ms. However, other values can also be used.

The embodiments also relate to a brake arrangement. The brake arrangement comprises a shaft, wherein, when the shaft is rotated in a first direction, application occurs and, when the shaft is rotated in a second direction, release occurs. This relates for example to a braking action, which can be realized, for example, by one or more brake shoes on a disk brake or drum brake. The brake arrangement has a gearwheel, which is connected to the shaft in a fixed rotation ratio. This can mean that the gearwheel is connected to the shaft for rotation therewith, i.e. rotates precisely together with the shaft. However, it may also mean that there is a transmission between the shaft and the gearwheel, and therefore an alternative rotation ratio can be achieved. In this case, however, there is typically a defined connection between a rotation of the shaft and a rotation of the gearwheel. This is typically effective in both directions. The brake arrangement has a drive for rotating the shaft. This may be, for example, an electric motor. The brake arrangement has a pawl, wherein the pawl is movable between a first position and a second position. In the first position, the pawl is spaced apart from the gearwheel and, in the second position, is in engagement with the gearwheel or at least can be brought into engagement by rotation of the shaft in the second direction. In other words, the first position corresponds to a state in which the gearwheel is rotatable completely independently of the pawl, and, in the second position, the pawl acts to block the gearwheel, at least after the gearwheel has rotated until it comes into engagement with the pawl. The brake arrangement has an actuating device for moving the pawl between the first position and the second position. This may be for example a solenoid. The latter can move the pawl directly linearly. In the case of a monostable pawl, there is typically a preloading device which preloads the pawl into a position, for example into the first position. The pawl can then be moved out of this position, specifically by actuation of the actuating device. In the case of a bistable pawl, even without actuation of the actuating device, the pawl remains in each of the positions until the actuating device is actuated again for active movement. The brake arrangement may also have a control device which is configured to carry out a method as described herein. With regard to the method, reference can be made to all of the described embodiments and variants. For example, the control device can have processor means and storage means, wherein in the storage means program code is stored, during the execution of which the processor means carry out a method as described herein.

All of the features described with reference to the method, including and for example those relating to device features, can be correspondingly applied in the case of the brake arrangement. The same applies vice versa.

The embodiments furthermore relate to a non-volatile, computer-readable storage medium on which program code is stored, during the execution of which a processor carries out a method as described herein. With regard to the method, reference can be made to all of the embodiments and variants described herein.

For example, the mechanisms described herein can be used in a braking system, which can be designed for example as a hybrid system. This can for example mean that hydraulic brakes are provided on a front axle and that electrically actuated brakes are provided on the rear axle. However, it can also be used with other braking systems.

For example, when installed in a motor vehicle, the pawl can be horizontally movable, for example if the motor vehicle is standing on a flat surface. However, other orientations can also be used, e.g., vertically upward or downward or at intermediate angles.

### BRIEF DESCRIPTION OF THE DRAWINGS

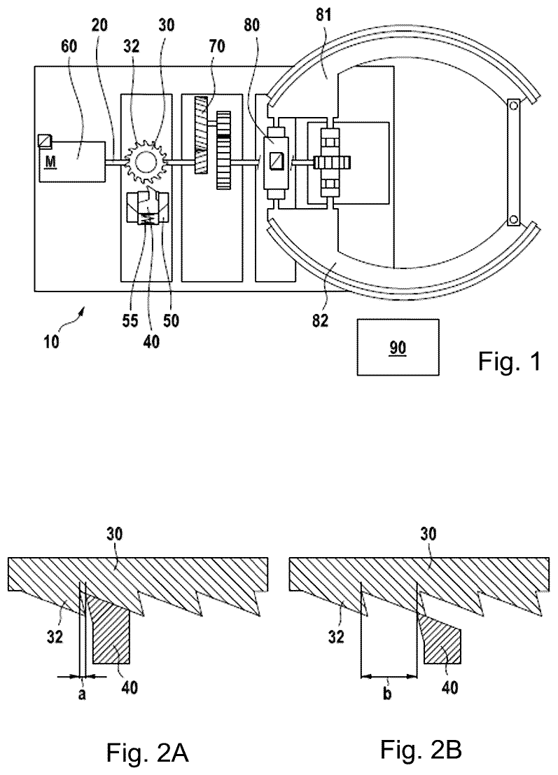

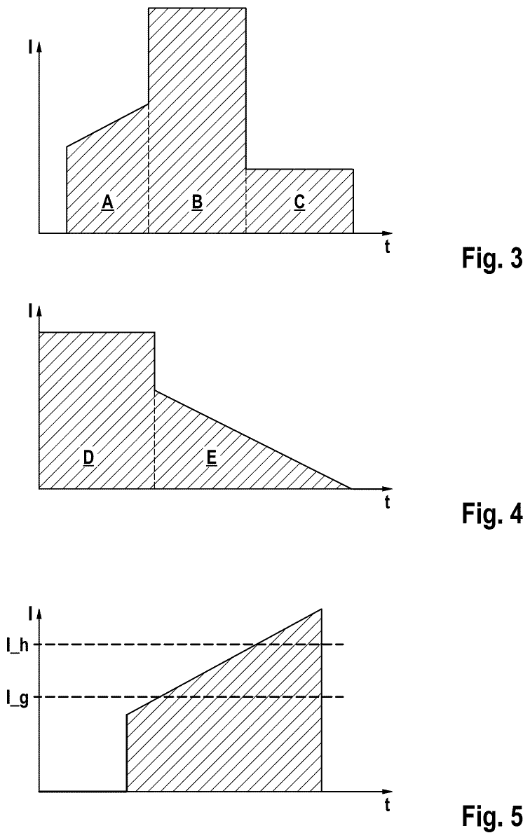

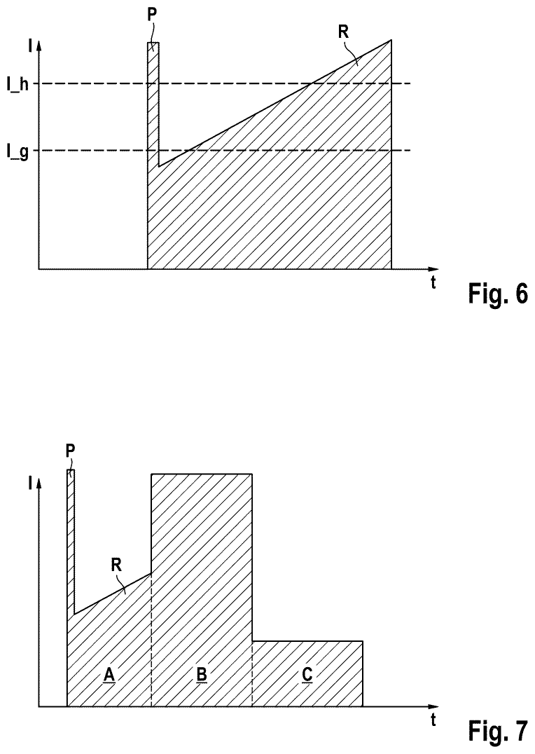

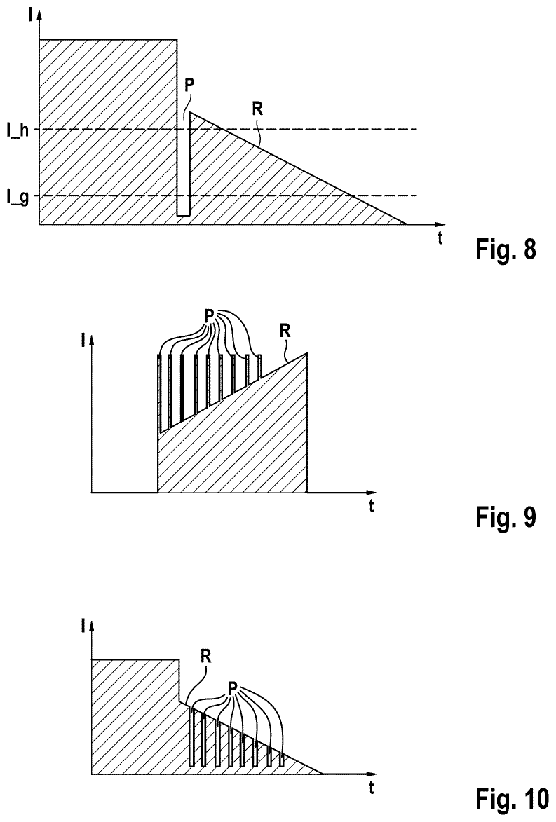

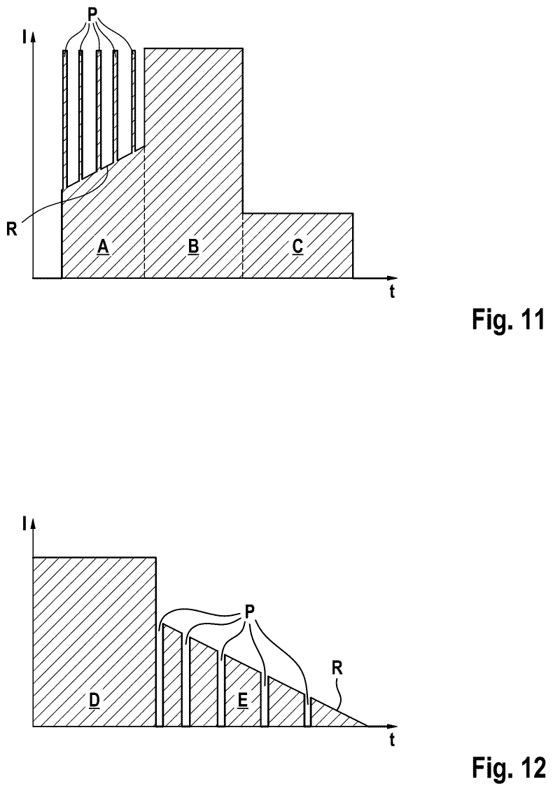

Further features will be gathered by a person skilled in the art from the embodiments described below with reference to the appended drawing, in which:

| | |
|---|---|
| FIG. 1 shows: | a brake arrangement, |
| FIG. 2A-B show: | parts of the pawl and the gearwheel, |
| FIG. 3 shows: | a current-time diagram, |
| FIG. 4 shows: | another current-time diagram, |
| FIG. 5 shows: | another current-time diagram, |
| FIG. 6 shows: | another current-time diagram, |
| FIG. 7 shows: | another current-time diagram, |
| FIG. 8 shows: | another current-time diagram, |
| FIG. 9 shows: | another current-time diagram, |
| FIG. 10 shows: | another current-time diagram, |
| FIG. 11 shows: | another current-time diagram, and |
| FIG. 12 shows: | another current-time diagram. |

### DETAILED DESCRIPTION

FIG. 1 shows a brake arrangement 10, by means of which a method described herein can be carried out.

The brake arrangement 10 has a shaft 20. A gearwheel 30 with a plurality of teeth 32 is attached to said shaft for rotation therewith. For blocking the gearwheel 30, the brake arrangement 10 has a pawl 40, which is one-dimensionally linearly movable. The pawl 40 can take up a first position in which it is not in engagement with the gearwheel 30, and which is shown in FIG. 1. It can be moved from this position to a second position, in which it is in engagement with the gearwheel 30 or can be brought into engagement by rotation of the gearwheel 30. An actuating device 50 in the form of a solenoid is used to actuate the pawl 40. A preloading device 55 in the form of a spring is used to preload the pawl 40 into the first position.

For driving the shaft 20, the brake arrangement 10 has a drive 60 in the form of an electric motor. The shaft 20 also acts on a transmission 70, which in turn acts on an expansion device 80. The latter expands two brake shoes 81, 82 against each other, so that they can achieve a desired braking effect, for example, on a drum brake. The transmission 70, the expansion device 80 and/or the brake shoes 81, 82 may be, but do not have to be, understood as meaning part of the brake arrangement 10.

By rotation of the shaft 20 by means of the drive 60 in a first direction, the braking effect is produced, i.e., applied, for example by expanding the brake shoes 81, 82 against each other. By rotation of the shaft 20 in a second direction, which is opposite to the first direction, the braking effect is released. This can be done by means of the drive 60, but rotation can also take place in the second direction because of internally acting forces or because of a device, not illustrated, which is designed for releasing the braking effect in the absence of an active actuation.

If the pawl 40 is moved to its second position, it comes into engagement with the gearwheel 30 and blocks further rotation thereof in the second direction. As a result, once an applied state has been reached, it can be maintained continuously. This corresponds to a parking brake functionality. Typically, the teeth 32 and the pawl 40 are shaped in such a way that, without further actuation, the pawl 40 is held in the second position by a positive fit with the gearwheel 30. Both the actuating device 50 and the drive 60 can then be currentlessly shifted without the parking brake functionality being lost.

For the control of the brake arrangement 10, the latter has an electronic control device 90. This can be configured for example to control the drive 60 and the actuating device 50 and can be configured for example to carry out a method described herein.

A travel distance of the pawl 40 can be reduced for example by the gearwheel 30 being positioned with respect to the pawl 40 in such a way that the pawl 40 has a reduced travel distance. This is illustrated in FIG. 2A-B. In the state of FIG. 2A, the pawl 40 is extended substantially further than in the state of FIG. 2B. Accordingly, a distance a from the next tooth 32 on the left side to the pawl 40 changes to a larger distance b. A movement of the gearwheel 30 can thus actively push the pawl 40 away and thus ensure a shorter subsequent movement. In the reverse case in which the pawl 40 is inserted, in the state of FIG. 2B a smaller travel distance is required than in the state of FIG. 2A.

If there is an intention to move back the pawl 40 which is in the second position, the following algorithm can be used:
energizing the pawl 40 to hold it in front
rotating back the gearwheel 30 until the energized pawl 40 is pushed back to the maximum by the gearwheel 30
reducing the current in the actuating device 50 so that the pawl spring or preloading device 55 can push back the pawl 40

If there is an intention to insert or move forward the pawl 40 which is in the first position, the following algorithm can be used:
positioning the gearwheel 30 until the energized pawl 40 is caught as early as possible by the gearwheel 30
increasing the current in the actuating device 50 in order to move the pawl 40 forward
when the actuating device 50 is energized, the gearwheel 30 is rotated back until the pawl 40 lies in the tooth pocket

Other possible options in conjunction with the reduction in pawl travel are indicated below:
monostable pawl release: at a high tooth position (current ramp, currentless, etc.) the current is reduced.
monostable pawl locking: at a high tooth position (current ramp, change in current, etc.) the current is increased.
bistable pawl release algorithm: at a high tooth position, the pawl is actuated in the release direction.
bistable pawl locking algorithm: at a high tooth position, the pawl is actuated in the locking direction.
different current ramps or current activations should be covered.
the absolute position of tooth to pawl or the relative position can be used (to move back by a certain angle when the pawl is applied).
the insertion of the pawl can also be thereby covered. In this case, the pawl is to be operated with the aim of having a minimum acceleration distance.

A reduction in the travel distance of the pawl 40 enables for example a better behavior in relation to noise, vibration, harshness (NVH) to be achieved. In addition, the mechanical wear of the pawl 40 can be reduced.

FIGS. 3 to 12 show current-time diagrams which explain the use of superimposing pulses and ramp. In principle, the current I is applied on the vertical axis by the actuating device 50 and the time t is applied on the horizontal axis.

With reference to FIG. 3, an activation concept known according to the prior art is first of all described in order to bring the pawl 40 into a locking position, i.e., the second position. First of all, phase A is driven with a current ramp with increasing current to reduce switching noises. A switching current is then applied in phase B in order to safely move the pawl 40 to its second position. Subsequently, phase C is reduced to a holding current.

To move the pawl 40 back to the first position, according to one option, the pawl 40 can be released from the gearwheel 30, i.e. by rotation of the gearwheel 30, a positive fit is released. According to a second option, as shown in FIG. 4, in phase D a holding current is initially applied and is then lowered in a ramp in phase E. This leads to a slower movement of the pawl 40. The current here counteracts the effect of the preloading device 55, which, however, because of the decreasing current brings the pawl 40 to the first position.

FIG. 5 shows, by way of example, the course of a ramp over time, wherein I_h specifies a current value which is necessary to overcome the static friction, and I_g specifies the current value which is necessary to overcome the sliding friction and to keep a moving pawl 40 in motion. I_h is always greater than I_g.

Static friction can be generated at the pawl 40, for example, by friction on surfaces or tilting of the pawl 40 because of the previously applied gearwheel torque. The force required to overcome the static friction is much higher than that required to overcome the sliding friction. If only one gradient is used, the force may become higher than required to overcome the sliding friction. This can lead to excessive acceleration of the pawl 40.

This can be improved, for example, by superimposing a slow basic component, for example a ramp, and short pulses. This allows the static friction to be overcome initially by high and/or short pulses. The remaining sliding friction is subsequently overcome with minimal current.

For example, the current profile can be a superimposition of two basic functions. To overcome the static friction component, the slow current function can be extended with stronger and shorter pulses to initiate a breakaway movement. To overcome the remaining sliding friction component, a slow and/or undynamic current function can be operated, e.g. a current ramp or a current holdover. The slow function can have a positive, negative, or zero gradient. The superimposed current pulses can be positive (i.e., a current increase) or negative (current decrease). A dynamic current pulse can be maintained until a movement is sensed by the inductive position determination. A switch is then made to the static low current function. When the locking position is reached in the desired manner, a change can be made to a holding current. When the release position is reached in the desired manner, the energizing can be stopped.

For example, the amplitude of a pulse should be high enough to be able to overcome the static friction. For example, the pulse or pulses should be short enough in order, after the breaking away, to not immediately reach the end position of the pawl 40.

A starting value of the slow function can be determined by test activation or from empirical values in which the sliding friction is overcome. Due to tolerances in the sliding friction, for example because of temperature or lubricants, a ramp may be used.

FIG. 6 shows an exemplary implementation of a locking operation. First of all, a pulse P is used followed by a current ramp R. The current level I_h required to overcome the static friction is overcome by the pulse P and then the pawl 40 can be moved with a lower current value to overcome the sliding friction.

The pulse P may be switched until the inductive position determination detects a movement, and is then switched over to the lower current value. Optionally, the slow current function is a ramp or a constant value.

In the embodiment according to FIG. 7, a breakaway pulse P is followed by phases A, B, C, as this has already been described further above with reference to FIG. 3. According to one embodiment, the switching current in phase B can always occur, or, according to an alternative embodiment, it can occur only if a position sensing has not detected any breakaway of the pawl 40. The switching current ensures that the pawl 40 always moves to the desired position.

FIG. 8 shows a possible sequence during a release operation. A holding current is first of all applied, followed by a pulse P, which is negative in comparison to the ramp R, i.e., very greatly reduces the current. In the process, the pawl 40 will typically break away and be set into motion. It is then moved back in a gentle and controlled manner by the ramp R into the first position.

However, it may be provided that not only one pulse P is used, but that a plurality of pulses P are used, for example in the absence of position determination.

FIG. 9 shows this for the case of movement from the first position into the second position with superimposition of ramp R and a plurality of pulses P. FIG. 10 shows this for the case of movement from the second position into the first position with superimposition of ramp R and a plurality of pulses P.

FIG. 11 shows an extension of the case which is shown in FIG. 9 and corresponds to phase A in FIG. 11 by a switching current in phase B and a holding current in phase C. It can be ensured by the switching current in phase B that an actuation takes place should this not yet have taken place in phase A contrary to expectations. FIG. 12 shows the embodiment from FIG. 9 with an alternative pulse sequence and phase division taken from FIG. 7.

The pulses can be repeated, for example, until a breakaway has been detected.

For example, a test activation outside a desired release or locking requirement determines the currents at which the pawl 40 moves. The inductive position measurement can be used for this purpose. These learnt current values can then be incorporated in the current profile, e.g., starting value and gradient of the ramp, height and duration of the pulses. This test activation should be performed without applying the clamping force of the brake and advantageously tooth-on-tooth.

If an undesired pawl position is determined after the quiet current profile by a position measurement of the pawl 40, a subsequent rapid and loud current profile can be driven in order to bring the pawl 40 hard into position. If locking is desired, the pawl 40 can first be fully released and moved to the locking position with a subsequent switching current. This is a routine that is never needed, but can quickly set the desired position if necessary. If it allows a position determination, the breakaway pulse can be applied until a breakaway is detected and then a change can be made to a lower current value.

The current mentioned can be set for example by means of a current regulator and for example by means of pulse width modulation. A frequency of 13.75 kHz is often used for this since this frequency can be poorly perceived by the human ear.

For example, for an intended operation of the pawl 40, a lower frequency for the pulse width modulation is initially used in a first period of time. This results in longer periods of time and pauses and higher peak-to-peak values in the current for the same mean current. This allows a fixed pawl 40 to be released. It is then possible to switch back to a higher frequency. The first period of time can also coincide with the respective first phase in the figures discussed above and/or with one or more pulses. For example, the lower frequency can therefore be used in phase A and in phase D and/or in superimposed pulses, if present. In the other phases, a higher frequency can be used.

A low frequency can also be used until a breakaway is detected. The use of a plurality of different frequencies, i.e., more than two frequencies, is also possible in principle, for example within a ramp. For example, the frequency can be changed, for example, reduced, continuously, or else briefly and/or in a pulsed manner.

Steps of the method that have been mentioned may be carried out in the order stated. They may however also be carried out in a different order if this is technically appropriate. In one of its embodiments, for example with a specific combination of steps, the method may be carried out in such a way that no further steps are carried out. In principle, however, further steps, even steps which have not been mentioned, may also be carried out.

It is pointed out that features may be described in combination in the claims and in the description, for example in order to facilitate understanding, even though said features can also be used separately from one another. A person skilled in the art will recognize that such features may also, independently of one another, be combined with other features or combinations of features.

Dependency references in dependent claims may characterize combinations of the respective features but do not exclude other combinations of features.

1. A method for actuating a brake arrangement comprising:
rotating a shaft in a first direction with a drive to apply a brake;
rotating the shaft in a second direction with the drive to release the brake; and
moving a pawl between a first position and a second position along a rectilinear travel distance with one of an actuating device and the drive;
wherein in the first position, the pawl is spaced apart from a gearwheel connected to the shaft in a fixed rotation ratio and in the second position, is in engagement with the gearwheel or can be brought into engagement by rotation of the shaft in the second direction.

2. The method as claimed in claim 1, further comprising controlling the actuating device and the drive such that during movement of the pawl from at least one of the first position into the second position and the second position into the first position there is at least temporary contact between the pawl and the gearwheel away from the second position such that a free movement length of the pawl is reduced.

3. The method as claimed in claim 1, further comprising actuating the drive such that, the pawl on the path into the second position contacts the gearwheel on a radial outer side of a tooth, and comes to a stop.

4. The method as claimed in claim 3, further comprising actuating the drive again, after the pawl is stopped against the gearwheel, such that the pawl continues to move into the second position.

5. The method as claimed in either of claim 3, wherein the contact on the radial outer side of the tooth takes place against a portion of the tooth that runs substantially perpendicular to the direction of movement of the pawl.

6. The method as claimed in claim 1, further comprising initially actuating the drive to move the pawl from the second position into the first position such that the gearwheel presses the pawl radially outward such that the pawl covers part of the travel distance in contact with the gearwheel.

7. The method as claimed in claim 6, further comprising rotating the gearwheel in the first direction with the drive such that the pawl is pushed radially outward along a back of a tooth.

8. The method as claimed in claim 6, wherein the deactivating the actuating device only after the pawl has travelled along part of the travel distance from the second position to the first position and such that the pawl then travels the rest of the distance to the first position without contact with the gearwheel.

9. The method as claimed in claim 1, further comprising activating the actuating device with a current and/or a voltage in accordance with superimposition of a ramp and at least one pulse.

10. The method as claimed in claim 9, wherein, starting from the ramp, the pulses point in the same direction as a profile of the ramp with increasing time.

11. The method as claimed in claim 9, wherein starting from the ramp, the pulses point in the opposite direction to a profile of the ramp with increasing time.

12. The method as claimed in claim 9, wherein only one pulse is used.

13. The method as claimed in claim 9, wherein a plurality of pulses are used.

14. The method as claimed in claim 9, wherein a pulse is used at the start of the ramp.

15. The method as claimed in claim 9, wherein a safety value which is higher or lower than all of the values used with the ramp is set after the ramp.

16. The method as claimed in claim 9, wherein a holding value is used after the ramp and/or after the safety value.

17. The method as claimed in claim 16, wherein the holding value is higher or lower than the safety value and/or than all of the values used with the ramp.

18. The method as claimed in claim 9, wherein at least one pulse is used until a movement of the pawl is sensed.

19. The method as claimed in claim 9, wherein a plurality of successive pulses are used until a movement of the pawl is sensed.

20. The method as claimed in in claim 9, wherein the ramp is rising, falling or constant.

21. The method as claimed in in claim 9, wherein the height of a pulse or a plurality of pulses is determined on the basis of a measurement, from which magnitude the pawl moves starting from a certain position.

22. The method as claimed in claim 1, wherein for the pawl to move the actuating device is activated in a first time window with a first pulse width modulation frequency and is activated in a second time window following the first time window with a second pulse width modulation frequency which is higher than the first pulse width modulation frequency.

23. The method as claimed in claim 22, wherein the first pulse width modulation frequency is at least 1 kHz and/or at most 6 kHz.

24. The method as claimed in claim 22, wherein the second pulse width modulation frequency is at least 6 kHz and/or at most 30 kHz.

25. The method as claimed in claim 22, wherein the first time window covers the ramp or is identical to the ramp.

26. The method as claimed in claim 22, wherein the second time window begins after the ramp or directly after the ramp.

27. The method as claimed in claim 22, wherein the first time window covers one or more pulses and/or is identical to the pulses.
